(19) United States
(12) Patent Application Publication
(10) Pub. No.: US 2025/0131245 A1
(43) Pub. Date: Apr. 24, 2025

(54) SYSTEMS AND METHODS OF PERFORMANCE DETERMINATION OF DIGITAL COMPONENTS BASED ON MACHINE LEARNING

(71) Applicant: The Kantar Group Limited, New York, NY (US)

(72) Inventors: Kalidas ASHOK, Mumbai (IN); Anirban PATHAK, Mumbai (IN); Archana VENKATRAJ, Mumbai (IN); Eluru SAIRAM, Mumbai (IN); Shreyas TATWAWADI, Mumbai (IN); Vikas VERMA, Mumbai (IN); Yaswanth Krishna VURUKOOTI, Mumbai (IN)

(73) Assignee: The Kantar Group Limited, New York, NY (US)

(21) Appl. No.: 18/491,473

(22) Filed: Oct. 20, 2023

(51) Int. Cl. G06N 3/0455; G06N 3/088

(52) U.S. Cl. CPC G06N 3/0455; G06N 3/088

(57) ABSTRACT

Performance determination of digital components based on machine learning is provided. A system extracts, from electronic evaluation surveys, strings indicative of performance of one or more digital components configured to render via client devices. The system constructs, for input into a first model including a transformer neural network, a prompt data structure formulated based on: i) the strings, ii) an indication of the one or more digital components, iii) an instruction to identify an aspect of the strings, and iv) a constraint on a size of output by the first model. The system generates a first output including aspects and terms extracted from the strings that are associated with the aspects generated by the first model. The system determines a metric indicative of performance of the one or more digital components. The system executes an action based on the metric to control delivery of the one or more digital components.

### BACKGROUND

It can be challenging to measure digital component effectiveness or performance of digital content in an efficient and reliable manner without introducing excessive errors or delays.

### SUMMARY

An aspect of this disclosure can be directed to a system of performance determination of digital components based on machine learning. The system can include a computing system comprising one or more processors, coupled with memory. The computing system can extract, from a plurality of electronic evaluation surveys executed via a plurality of client devices over a network, a plurality of strings indicative of performance of one or more digital components configured to render via the plurality of client devices. The computing system can construct, for input into a first model comprising a transformer neural network, a prompt data structure formulated based on: i) the plurality of strings, ii) an indication of the one or more digital components, iii) an instruction to identify an aspect of the plurality of strings, and iv) a constraint on a size of output by the first model. The computing system can generate, via input of the prompt data structure into the first model, a first output comprising a plurality of aspects and a plurality of terms extracted from the plurality of strings that are associated with the plurality of aspects generated by the first model. The computing system can convert the plurality of terms of the first output into embedding vectors. The computing system can create, via input of the embedding vectors into a second model trained with machine learning to cluster, a plurality of clusters for the first output of the first model. The computing system can determine a metric indicative of performance of the one or more digital components based on a count of the plurality of strings associated with a cluster of the plurality of clusters. The computing system can execute an action based at least in part on the metric to control delivery of the one or more digital components.

An aspect of this disclosure can be directed to a method. The method can include extracting, from a plurality of electronic evaluation surveys executed via a plurality of client devices over a network, a plurality of strings indicative of performance of one or more digital components configured to render via the plurality of client devices. The method can include constructing, for input into a first model comprising a transformer neural network, a prompt data structure formulated based on: i) the plurality of strings, ii) an indication of the one or more digital components, iii) an instruction to identify an aspect of the plurality of strings, and iv) a constraint on a size of output by the first model. The method can include generating, via input of the prompt data structure into the first model, a first output comprising a plurality of aspects and a plurality of terms extracted from the plurality of strings that are associated with the plurality of aspects generated by the first model. The method can include converting the plurality of terms of the first output into embedding vectors. The method can include creating, via input of the embedding vectors into a second model trained with machine learning to cluster, a plurality of clusters for the first output of the first model. The method can include determining a metric indicative of performance of the one or more digital components based on a count of the plurality of strings associated with a cluster of the plurality of clusters. The method can include executing an action based at least in part on the metric to control delivery of the one or more digital components.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example system of performance determination of digital components based on machine learning, according to an embodiment.

FIG. 2 depicts an example flow chart of a method for performance determination of digital components based on machine learning, according to an embodiment.

FIG. 3 depicts an example digital rendering of performance determination of digital components based on machine learning, according to an embodiment.

FIG. 4 depicts an example flow chart of a method for performance determination of digital components based on machine learning, according to an embodiment.

FIG. 5 is a block diagram illustrating an architecture for a computer system that can be employed to implement elements of the systems and methods described and illustrated herein, including aspects of the system depicted in FIG. 1, the digital rendering in FIG. 3, and the methods depicted in FIG. 2 and FIG. 4.

### DETAILED DESCRIPTION

Following below are more detailed descriptions of various concepts related to, and implementations of, methods, apparatuses, and systems for performance determination of digital components based on machine learning. The various concepts introduced above and discussed in greater detail below can be implemented in any of numerous ways.

This disclosure is directed to systems, methods, and apparatuses for performance determination of digital components based on machine learning. Some entities (e.g., companies, corporations, groups, clients, customers) can create virtual content to be rendered on client devices. For example, a company can create an digital component for a product to be rendered on a user device of a potential customer. To determine a performance of the virtual content (e.g., customer perception), the entity can send an electronic evaluation survey to the client devices. Responses gathered by the survey can be analyzed and used to determine in what ways the virtual content was received positively or negatively. However, determining performance of virtual content based on survey responses can be inaccurate, utilize a large number of resources (e.g., computing resources, memory resources, or network resources), and be inefficient, among other deficiencies.

Aspects of these technical solutions can overcome at least the aforementioned technical deficiencies. For example, the technical solution can determine a metric indicative of performance of one or more digital components. To do so, the technical solution can extract strings (e.g., responses, sequence of characters) indicative of performance of the one or more digital components from electronic evaluation surveys. The technical solution can construct input for a transformer neural network model based on a prompt data structure. The prompt data structure can be formulated based on the strings, an indication of the digital components, an instruction to identify an aspect of the strings, and a size constraint. The technical solution can generate an output via the transformer neural network model based on the input. The output can include terms and aspects associated with the strings. The technical solution can convert the terms into embedding vectors. The technical solution can input the embedding vectors into a machine learning model to create clusters for the output of the transformer neural network model. The technical solution can determine a metric indicative of performance of the digital components based on a count of the strings associated with a cluster of the clusters. The technical solution can execute an action based on the metric to control delivery of the digital components to client devices.

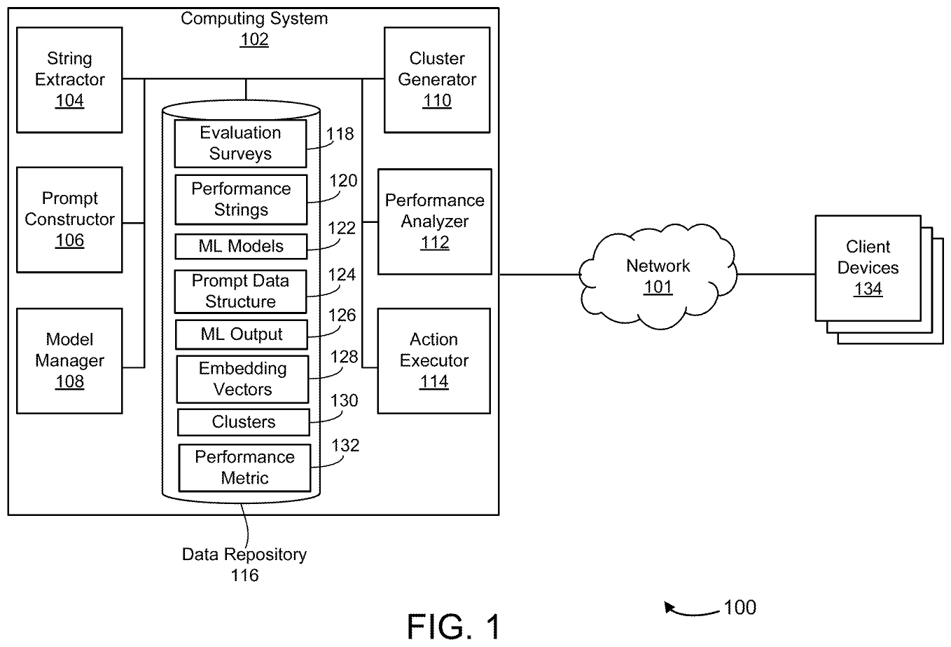

FIG. 1 depicts an example system 100 of performance determination of digital components based on machine learning. The system 100 can include a computing system 102. The computing system 102 can include a string extractor 104 to extract strings indicative of performance of digital components (e.g., advertisements, digital renderings, displayable content). The computing system 102 can include a prompt constructor 106 to construct a prompt data structure for input into a first model. The computing system 102 can include model manager 108 to generate output from the first model including a transformer neural network including aspects and terms associated with the strings. The computing system 102 can include a cluster generator 110 to cluster the first output into multiple clusters of terms. The computing system 102 can include a performance analyzer 112 to determine metrics indicative of performance of the digital components. The computing system 102 can include an action executor 114 to execute an action to control delivery of the digital components based on the metric. The computing system 102 can include a data repository 116 to store and manage data, such as evaluation surveys 118, performance strings 120, machine learning models 122, prompt data structures 124, machine leaning output 126, embedding vectors 128, clusters 130, and performance metrics 132.

The computing system 102 can interface with, communicate with, or otherwise receive or provide information with the client devices 134 via the network 101, as well as other devices, systems, or entities in communication with the network 101. The computing system 102 and the client devices can each include at least one logic device such as a computing device having a processor to communicate via the network 101. The computing system 102 and the client devices 134 can include at least one computation resource, server, processor, or memory. For example, the computing system 102 can include a plurality of computation resources or processors coupled with memory.

The network 101 can include computer networks such as the Internet, local, wide, metro, or other area networks, intranets, satellite networks, and other communication networks such as voice or data mobile telephone networks. The network 101 can include wired or wireless networks, connections, or communication channels. The network 101 can be used to transmit or receive information or commands to or from various components or sources. The network 101 can be any type or form of network and can include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network, or a wireline network.

The computing system 102 can be part of or include a cloud computing environment. The computing system 102 can include multiple, logically grouped servers and facilitate distributed computing techniques. The logical group of servers can be referred to as a data center, server farm, or a machine farm. The servers can also be geographically dispersed. A data center or a machine farm can be administered as a single entity, or the machine farm can include a plurality of machine farms. The servers within each machine farm can be heterogeneous-one or more of the servers or machines can operate according to one or more type of operating system platform. In some implementations, the computing system 102 can be a type of client device 134, such as a computer, a laptop, a tablet, a phone, or any other type of device including one or more processors and memory capable of performing the functions as described herein.

The action executor 114 can be designed, constructed, and operational to manage connections between the computing system 102 and the client devices 134. In some implementations, the action executor 114 can manage direct connections to any one of the client devices 134 or can manage indirect connections to any one of the client devices 134 via the network 101. The connections can be wireless communication sessions. For example, the action executor 114 can establish a wireless communication session with the client devices 134.

To establish a connection or wireless communication session, the action executor 114 can perform, facilitate, or otherwise execute a handshaking process. The handshaking process can be pursuant to a wireless networking protocol, such as a short-range wireless communication protocol (e.g., Bluetooth), Wi-Fi, or a nearfield communication protocol (e.g., NFC). In some cases, the communication can be wired (e.g., universal serial bus “USB”, ethernet, or communication cable).

The action executor 114 can establish a wireless communication session with the client devices 134 via an intermediary device, such as a hub, meter, gateway, or router. For example, the action executor 114 can establish the wireless communication session via a router, such that the computing system 102 can transmit digital components and evaluation surveys and receive responses to the surveys to and from the client devices 134. In some cases, the action executor 114 can increase or reduce a frequency of delivery of one or more digital components based on the performance metric 132 associated with a survey 118 of the digital components.

The string extractor 104 can be designed, constructed, and operational to extract strings 120. The strings 120 can include text data from responses to the evaluation surveys 118 received from the client devices 134. The strings 120 can include text data indicative of performance of digital components sent to the client devices 134. For example, the client devices 134 can receive an digital component associated with an entity (e.g., company, corporations, groups, clients, customers). To determine a performance of the digital component (e.g., a reception by users of the client devices 134 to the digital component, to measure digital component effectiveness), the computing system can send the evaluation surveys 118 to the client devices 134. Responsive to the client devices 134 submitting a response to the evaluation surveys 118, the string extractor 104 can determine and extract text data indicative of the performance of the digital component from the response. The string extractor 104 can perform any parsing or extraction technique to identify the text data from the response data to the evaluation surveys 118. The string extractor 104 can obtain the response data from any one of the client devices 134, the action executor 114, or the network 101. The string extractor 104 can use any communication protocol or application programming interface (API) to fetch, obtain, retrieve, query, request, or otherwise obtain the data.

The prompt constructor 106 can be designed, constructed, and operational to construct prompt data structures 124. The prompt constructor 106 can construct the prompt data structures 124 from the strings 120. In some cases, the computing system 102 can be configured (e.g., pre-configured, uploaded in software) with the prompt data structures. The prompt data structures 124 can include at least a first type of prompt and a second type of prompt. The first type of prompt data structure 124 can be formulated based on the strings 120, an indication of the digital components (e.g., a description, an identification, other contextual data), an instruction (e.g., rule, command) to identify an aspect of the strings, and a constraint on a size of output. For example, the size of the output can be constrained to be 2, 5, 7, 10, or another number of words to reduce latency and excess memory usage in generating the output and using the output in further calculations. The second type of prompt data structure 124 can be formulated based on instructions (e.g., rules, commands) to generate topics for clusters 130 created by a model 122 and instructions to generate a summary for each cluster 130.

The model manager 108 can be designed, constructed, and operational to input data into the models 122. For example, the model manager 108 can input the first type of prompt data structure 124 into a transformer neural network model 122 (e.g., an encoder network model, a decoder network model, a sequence2sequence network model, a large language model, a self-attention transformer model, or deep neural network model). The model 122 can be a model, a machine learning function or technique, or a model trained with a machine learning function or technique. The model can be a supervised or unsupervised machine learning model.

For example, the model 122 can include a self-attention transformer model 122 that can include various component. For example, the self-attention transformer model 122 can include input embeddings that can transform the input into embeddings. The self-attention transformer model 122 can include a self-attention mechanism to compute attention scores for each input element relative to other elements. These scores can represent the relevance or importance of each element to others, and can be calculated in parallel for the input elements. The self-attention transformer model 122 can include multi-head attention to allow the model to focus on different aspects of the input attention, while each head can learn different relationships in the data. The self-attention transformer model 122 can include a position-wise feedforward network that can be applied to each element independently to capture complex patterns in the data. The self-attention transformer model 122 can multiple layers that are stacked on top of one another to allow the model to capture increasingly complex patterns. The self-attention transformer model 122 can include an output layer to provide an output.

For example, the model can recognize or identify patterns in data without any, or with minimal, user supervision. The model can be a model or machine learning function or technique trained using a dataset. For example, the machine learning model can be (1) pre-trained commercial large language or other foundation models, (2) pre-trained open-source models, (3) open-source models fine-tuned on specific data, or (4) foundation models trained from scratch. Training or fine-tuning data can include some combination of text documents, words, sentences, or other sequences of text, questions, and answers in natural language, quantitative data, or tables with numeric data, images, audio tracks, videos, or charts. Training can be done with respect to a variety of tasks such as next word prediction, answering questions, writing code, interpreting contents of an image, sentiment identification, or general attribute identification.

The model manager 108 can generate, via input of the first type of prompt data structure 124 into the model 122, an output 126 from the model 122. The output 126 can include multiple aspects. The aspects can include a theme, topic, or one or more words describing the contents of the string. The aspects can be a word included in the string or another word related to the contents of the string. The output 126 can include multiple terms extracted from the strings, the terms associated with the aspects (e.g., including the aspects, related to the aspects). The terms can include a subset of the strings (e.g., a subset of words, characters, text data). The terms can include one or more words contiguous with the aspect in the string, one or more words of the string directed towards the aspect of the string, or one or more words directed towards the aspect of the string.

The model manager 108 can generate, via input of the second type of prompt data structure 124 into the model 122, a second output 126 from the model 122. The second output 126 can include topics (e.g., topic names) and summaries. The topics can include a topic name for each cluster 130 (e.g., grouping, set) of terms. In some cases, the topics can be a title for a grouping of related aspects. The topics can include one or more words, where the one or more words can include words from one or more aspects of the cluster 130. The summaries can include a summary for each topic. The summaries can include a concise summary of the cluster 130 (e.g., the number of terms included in the cluster 130, the number of aspects included in the cluster 130, a description of the contents included in the terms of the cluster 130, other data about the cluster 130).

The cluster generator 110 can be designed, constructed, and operational to generate (e.g., create, group, cluster, form) a cluster 130. To do so, the cluster generator 110 can convert the terms and/or the aspects of the first output 126 into embedding vectors 128. For example, the cluster generator 110 can use any algorithm, function, or method to map the terms and/or aspects to a corresponding vector of numbers. The cluster generator 110 can use one or more types of embedding mappings to map the terms and/or aspects (e.g., the cluster generator 110 can create multiple vector embeddings using a respective embedding method and take an average vector embedding). The cluster generator 110 can input the embedding vectors 128 (e.g., one vector embedding, an average of multiple vector embeddings) into a second model 122 trained with machine learning to cluster related (e.g., coherent) words based on the embedding vectors 128. The cluster generator 110 can determine a cluster score based on a distance between each embedding vector 128 of a cluster 130. If the cluster score is below a threshold cluster score, the cluster generator 110 can generate second clusters 130 that include more clusters than a previous number of clusters generated (e.g., the cluster generator 110 can break up the clusters 130 into smaller clusters 130).

The performance analyzer 112 can be designed, constructed, and operational to determine a metric 132 indicative of performance of the digital components based on a count of the strings associated with a cluster 130. For example, each cluster 130 can include a different number of terms. The metric 132 can indicate a relative performance of each cluster 130 to each other cluster 130 (e.g., a percentage of terms in the cluster compared to the total number of terms collected). The metric 132 can indicate a sentiment of each cluster 130 (e.g., a total sentiment, an average sentiment). The sentiment can be positive, neutral, negative, or can include more granular descriptors (e.g., a total number value, an average number value, a range of sentiment descriptors). For example, each term can be associated with a sentiment (e.g., I like the music, I dislike the music, I love the music, the music was prevalent). The performance analyzer 112 can map each sentiment to a numerical value (e.g., 1, 0, −1) and combine each numerical value of the cluster 130 to determine the sentiment of each cluster 130.

In some cases, the performance analyzer 112 can process feedback. For example, an administrator or user can provide feedback regarding the generated topic names, the clustering, coherence for each cluster 130, identified aspects, among other types of feedback. The performance analyzer 112 can provide the feedback to the model manager 108 to cause the model manager 108 to update the models 122 based on the feedback.

The action executor 114 can be designed, constructed, and operational to execute an action. The action executor 114 can execute the action based on the metric 132 of each cluster 130. For example, if the metric 132 is less than or equal to a performance threshold, the metric 132 can indicate the content rendered (e.g., the digital components) is undesirable to an audience (e.g., the users of the client devices). The computing system 102 can determine subsequent content to be different from the previous content based on the metric 132 and/or reduce a frequency of delivery of the previous content. If the metric 132 is greater than or equal to a performance threshold, the metric 132 can indicate the content rendered is desirable to an audience. The computing system 102 can determine subsequent content to be similar to the previous content based on the metric 132 and/or increase a frequency of delivery of the previous content. In some cases, the action executor 114 can determine a first metric 132 associated with a first topic of previous content is greater than the performance threshold and a second metric 132 associated with a second topic of the previous content is less than the performance threshold. The action executor 114 can determine subsequent content to be similar to the first topic of the previous content and different from the second topic of the previous content.

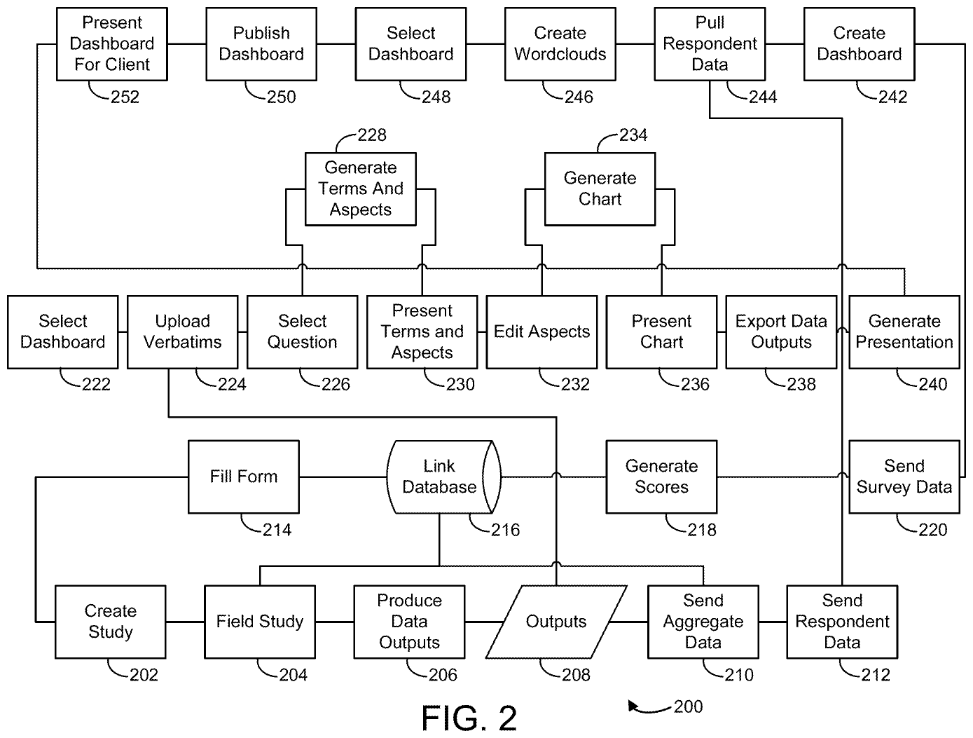

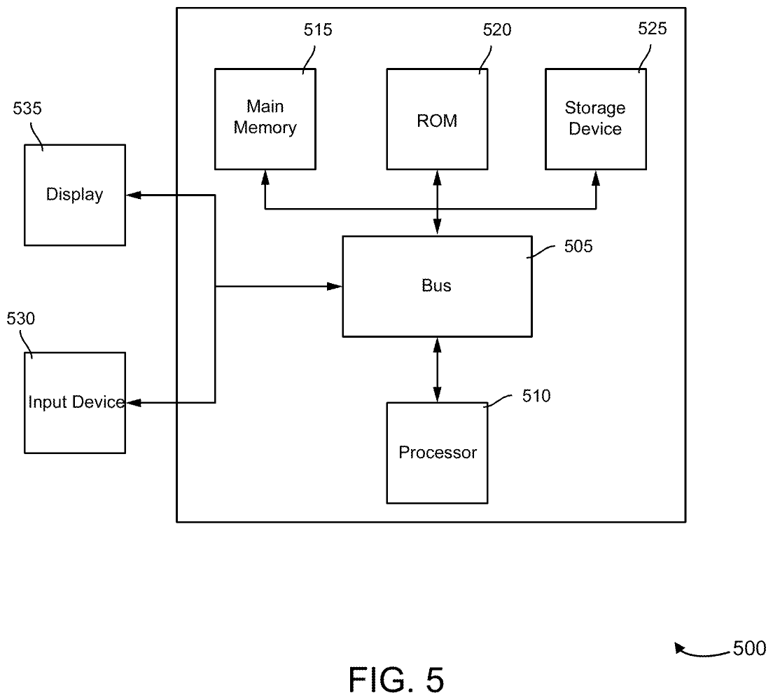

FIG. 2 depicts an example flow chart of a method 200 for performance determination of digital components based on machine learning. The method 200 can be performed by one or more systems or components depicted in FIG. 1 or FIG. 5, including, for example, a computing system 102, client devices 134, or a computer system 500. In some cases, the systems can include one or more of an automation platform system, a normative system, a user interface system, a neural network system, or a dashboard system. Each of the acts can be performed by a computing system, a moderator, a user of the computing system, or another entity (e.g., a cloud server, one or more remote processors). While the acts of the method 200 are described according to an order, any subset or all of the acts can be performed in any order, simultaneously, or omitted.

Some entities (e.g., companies, corporations, groups, clients, customers, systems) can create virtual content (e.g., digital components) to be rendered on client devices. For example, a company can create an digital component for a product to be rendered on a user device of a potential or current customer. To determine a performance of the virtual content (e.g., customer perception), the entity can send an electronic evaluation survey to the client devices. Responses gathered by the survey can be analyzed and used to determine in what ways the virtual content was received positively or negatively (e.g., a performance of the virtual content). However, determining performance of virtual content based on survey responses can be inaccurate, use a large amount of computing resources (e.g., processor utilization, memory utilization, or network utilization), and be inefficient, among other deficiencies.

The techniques described herein can overcome the aforementioned technical difficulties by being expandable (e.g., based on subsequent client behaviors and natural language being added to a training set for a machine learning model training process) and reducing or eliminating at least portions of the performance verification process (e.g., due to the model being able to quickly identify or generate terms, aspects, and topics and cluster the survey responses).

At ACT 202, a computing system can create a study. For example, the study can include multiple electronic evaluation surveys executed via multiple client devices over a network. The surveys can be associated with digital components (e.g., components depicting one or more digital components for an entity) rendered via the client devices or via another device (e.g., display) in proximity to the client devices (e.g., proximal to a user of the client device such that the user can see the digital component and respond to the survey via the client device).

At ACT 204, the computing system can field the study. The computing system can store the study in a link database 216. The study can include contextual information about the survey (e.g., location, time, number of respondents, type of digital component, entity associated with the digital component) and responses to the survey (e.g., open ended responses).

At ACT 206, the computing system can produce data outputs. The computing system can store the data outputs in outputs database 208. For example, the computing system can extract, from the electronic evaluation surveys, strings indicative of performance of the digital components configured to render via the client devices. In some cases, the strings can be data associated with the responses to the surveys. The strings can include a portion or all of the textual data of the responses.

At ACT 210, the computing system can send aggregate data. The computing system can store the aggregate data in the link database 216. The aggregate data can include an aggregation of survey data collected from the electronic evaluation surveys. At ACT 212, the computing system can send respondent data. The computing system can send respondent data in response to a pull request (e.g., at ACT 244). The respondent data can include the strings and other data associated with respondents to the survey (e.g., data associated with the client devices, the user of the client devices). The computing system can send the respondent data to a dashboard.

At ACT 214, the computing system can fill a form (e.g., the survey). The computing system can store the form, contextual information associated with the fielded study, and/or the aggregate data in the link database 216. In some cases, the computing system can fill the form based on responses from users of the client devices. At ACT 218, the computing system can generate scores. For example, the computing system can input the form, the contextual information, the aggregate data, and/or other data of the link database 216 into a calculation engine to generate the scores. In some cases, the scores can be performance metrics associated with how well an digital component was received by an end user of the client devices. In some cases, the scores can include a value representative of a sentiment. For example, the sentiment can have a value of 1 if the response was positive, a value of 0 if the response was neutral, or a value of −1 if the response was negative.

At ACT 220, the computing system can send survey data. For example, the computing system can send the survey data to the dashboard. The survey data can include data from the link database 216, the generated scores associated with the surveys, or both.

At ACT 222, the computing system can select a dashboard. The dashboard can be of a type of dashboard selected from multiple types of dashboards. For example, each type of dashboard can include a different format. The formats can be various user interface templates formulated based on a configuration of digital components. The dashboard can depict information about the surveys, digital components, responses, or any combination thereof. In some cases, the dashboard can be an example of a digital rendering 300.

At ACT 224, the computing system can upload the strings (e.g., verbatims). For example, the computing system can construct, for input into a first model including a transformer neural network, a prompt data structure. The computing system can formulate the prompt data structure based on the strings, an indication of the digital components (e.g., an identification, a description), an instruction to identify an aspect of the strings, and a constraint on a size of output by the first model. In some cases, the computing system can construct the prompt data structure with a second instruction to identify one or more sentiments associated with the strings. For example, the prompt data structure can have as input the strings and a description. The prompt data structure can include commands or rules for generating terms, aspects, and sentiment associated with the strings. For example, the prompt data structure can include a command to perform one or more of the following actions: i) find all aspects in less than a number (e.g., 2, 5, 10) of words from the text (e.g., the strings) and its associated sentiment. Sentiment can be 1: positive, 0: neutral, or −1: negative. ii) if you don't find any aspect in the text, then output [Aspect: other—no aspects][Sentiment: sentiment of the text][Words: None]. iii) else, for each aspect you find, extract the part of the text associated with that aspect and the sentiment associated with it. Then, return all the aspects, sentiment, and text extracted in the format [Aspect: aspect you find][Sentiment: associated sentiment][Words: associated text].

At ACT 226, the computing system can select a question. For example, the computing system can select an open-ended question from the survey. The computing system can determine responses to the open-ended question. The computing system can input the prompt data structure, with data from the selected question, into the first model.

At ACT 228, the computing system can generate terms and aspects. For example, the computing system can generate a first output including the terms and aspects via the first model using the input of the prompt data structure. In some cases, the terms can be string snippets (e.g., a sub-string of a string) that include or are associated with an aspect (an intent of the survey response). In some cases, the aspects can include a theme or topic of the string (e.g., what the string is about, cartoon, digital component length, digital component look, digital component feel, digital component simplicity).

At ACT 230, the computing system can present the terms and aspects. For example, the computing system can convert the terms of the first output into embedding vectors. The computing system can create, via input of the embedding vectors into a second model trained with machine learning to cluster, multiple clusters for the first output of the first model. The clusters can be based on similar aspects. For example, the second model can cluster together aspects by coherence. To do so, the second model can be trained based on embeddings. Embeddings can be numeric representations of words that measure relatedness (e.g., similarity) of text strings (e.g., words). The embeddings can be lists (e.g., vectors) of numbers, where a distance (e.g., a difference in values) between two vectors measures the relatedness of the two vectors. If a coherence value (e.g., an average value of relatedness between each term of the cluster) of a cluster of terms does not satisfy a coherence threshold, the computing system can increase a number of clusters and iteratively generate clusters until the clusters satisfy the coherence threshold, or the clusters fall below a cluster size threshold (e.g., the clusters are too small to be broken up further).

In response to creating the clusters, the computing system can generate, via the first model, second output including a topic name and summary for each cluster. To do so, the computing system can use a second prompt data structure formulated based on instructions to generate topics for the clusters created by the second model and instructions to generate a summary based on the topics and the terms extracted from the strings. For example, the second prompt data structure can have the terms of the cluster as input. The second prompt data structure can include commands or rules for generating the topic name. The commands or rules can include a threshold size for the topic name, descriptors for how to determine the topic, instruction on generating a summary, among other types of commands or rules. In some cases, the commands or rules can include: i) find the major topic. ii) the topic name should be less than a number (e.g., 2, 3, 5) words. iii) use the topic and the extracts (e.g., terms) to generate a one-line summary. iv) the summary should be concise. v) return the topic and summary in the format [Topic: topic you find][Summary: summary you generate]. vi) else return [Topic: mixed topic name][Summary: mixed topic name]. At ACT 232, the computing system can edit the aspects, terms, or topic names. In some cases, the computing system can edit the aspects based on input from a user or administrator.

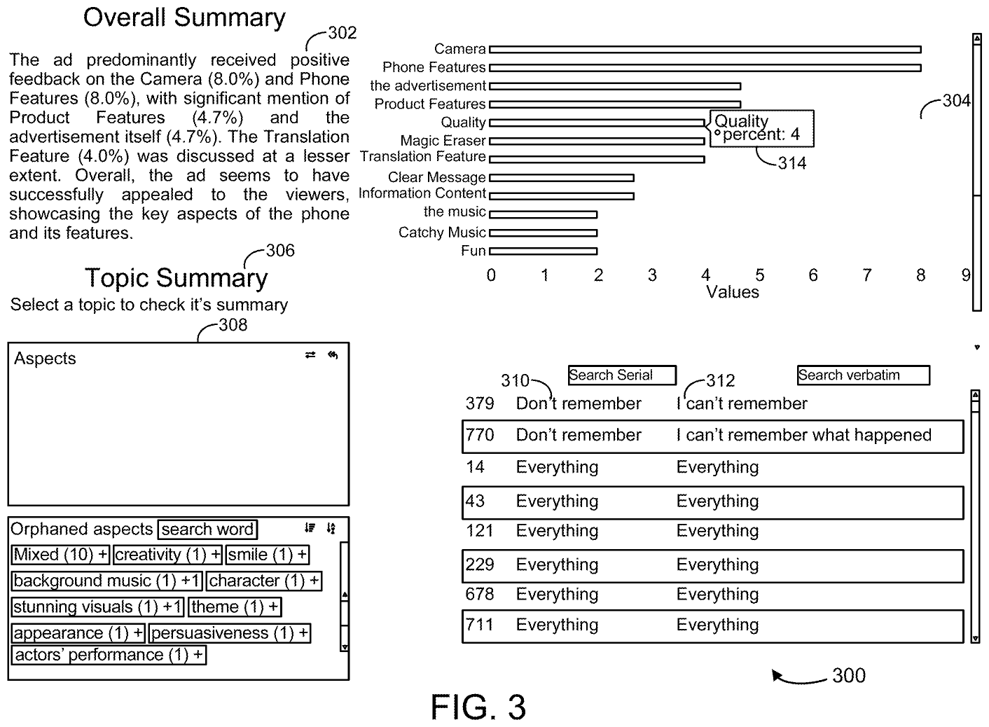

At ACT 234, the computing system can generate a chart. The computing system can generate the chart based on the count of the strings associated with a cluster of the generated clusters. For example, the chart can depict the topic name of the cluster and the count of strings associated with the cluster in ascending, descending, or other order. The chart can be a first type of chart of multiple types of charts. For example, the chart can be a bar chart, a pie chart, a scatter plot, among other chart types. In some cases, the chart can be an example of a chart 304 as described with reference to FIG. 3.

At ACT 236, the computing system can present the chart. For example, the computing system can provide, for display via a graphical user interface, the chart that indicates the count of the strings associated with each cluster. In some cases, the computing system can overlay, on a component of the chart (e.g., a bar of a bar chart), a metric indicative of performance of the digital components. At ACT 238, the computing system can export data outputs (e.g., topic names, topic summaries, aspects, terms, strings, charts, string count for each cluster, the clusters, metrics for each cluster). At ACT 240, the computing system can generate a presentation based on the data outputs. In some cases, the computing system can execute an action based on the metric, the data outputs, or other data regarding the survey responses. For example, the action can be to control delivery of the digital components (e.g., delivery of the digital components). The computing system can reduce a frequency of delivery of the digital components based on the metric being less than or equal to a performance threshold (e.g., the digital component underperforming, negative sentiment towards the digital component). The computing system can increase a frequency of delivery of the digital components based on the metric being greater than or equal to a performance threshold (e.g., the digital component overperforming, positive sentiment towards the digital component). For example, a frequency of delivery can be once a week, a day, every six hours, every hour, etc. The frequency of delivery can refer to delivery for a single device, user, geographic region, IP address, device identifier, account identifier, publisher (e.g., website, TV station), among other examples. In some cases, the performance threshold can be 10 percent, 15 percent, 50 percent, or another value. In some cases, the performance threshold can be 1 (e.g., an average positive sentiment), 0 (an average neutral sentiment), −1 (an average negative sentiment), or any value in a range between 1 and −1. In some cases, the performance threshold can be 2, 5, 10, −2, −5, −10, or another positive or negative value based on a combination of various sentiment values.

In some implementations, at ACT 242, the computing system can create a dashboard. The dashboard can be similar to the dashboard selected at ACT 222. At ACT 244, the computing system can pull the respondent data. For example, the computing system can pre-fill the dashboard (e.g., digital components of the dashboard) with the respondent data. At ACT 246, the computing system can create word-clouds. In some cases, the word-clouds can include the strings and other data from the respondent data. At ACT 248, the computing system can select the dashboard, similar to ACT 222. At ACT 250, the computing system can publish the dashboard.

At ACT 252, the computing system can present the dashboard to the clients (e.g., users). For example, the computing system can provide the chart, a list of topic names, a list of terms, a list of aspects, or other information associated with the survey responses (e.g., survey response data), for display via a graphical user interface. In some cases, the clients, administrators, or users of the dashboard can manipulate the dashboard and/or the survey response data. For example, the clients can apply one or more filters to the dashboard to change what information is presented on the dashboard. The clients can change a topic name and the computing system can update a database including the topic name with the changed topic name.

FIG. 3 depicts an example digital rendering 300 of performance determination of digital components based on machine learning. The digital rendering 300 can be generated (e.g., rendered, performed) by one or more systems or components depicted in FIG. 1 or FIG. 5, including, for example, a computing system 102, client devices 134, or a computer system 500. The digital rendering 300 can include one or more digital components. The digital components can correspond to (e.g., be visual representations, renderings, of) various outputs or calculations performed by the systems or components depicted in FIG. 1 or FIG. 5. For example, the digital rendering 300 can include an overall summary 302, a bar chart 304, a topic summary 306, topic names 308, aspects 310, terms 312, and metrics 314. The digital components depicted in FIG. 3 can be non-limiting examples of potential digital components rendered via the digital rendering 300. Other digital components associated with the various outputs or calculations by the systems or components depicted in FIG. 1 or FIG. 5 are considered (e.g., various types of charts, various navigation components, filters, and other modifying digital components).

In some examples, the digital rendering 300 can include data associated with a survey for a digital component. For example, the digital component can be rendered on multiple client devices. In response to the rendering of the digital component, the users of the client devices can be asked to participate in a survey. The survey can include one or more open ended questions, among other types of questions. For example, the questions can be directed towards determining what the users noticed about the digital component, remembered about the digital component, sentiment towards the digital component, among other types of questions. A computing system can extract terms 312 from the responses to the survey. The terms 312 can include a snippet of the response that indicates an aspect and a sentiment associated with the aspect, such as “I like the brand,” “the animation style is unique,” etc. The computing system can determine an aspect 310 associated with each term 312. For example, the aspect can be “brand,” “animation,” etc. The computing system can cluster the terms 312 based on coherent aspects. For example, coherent aspects can include related words, such as music, tone, tune, etc. The computing system can generate topic names 308 and a topic summary 306 for each cluster. For example, the computing system can generate music as a topic name 308 for a cluster including aspects such as music, tone, and tune. In some cases, the topic summary 306 can include metrics or other indications of a performance or sentiment of the cluster. The computing system can generate a chart 304 based on a count of terms for each cluster and the associated topic name. The chart 304 can be a visual representation of one or more metrics of each cluster (e.g., performance, importance, user preference). The computing system can determine a metric 314 indicative of performance of the digital component corresponding to each cluster (e.g., a percent based on the count for the cluster and a total count of responses, a sentiment value). The computing system can generate an overall summary 302 based on each cluster. The overall summary 302 can include a summary of a sentiment and/or performance of the digital component based on each cluster. The overall summary 302 can include the metric 314 for each cluster or for select clusters.

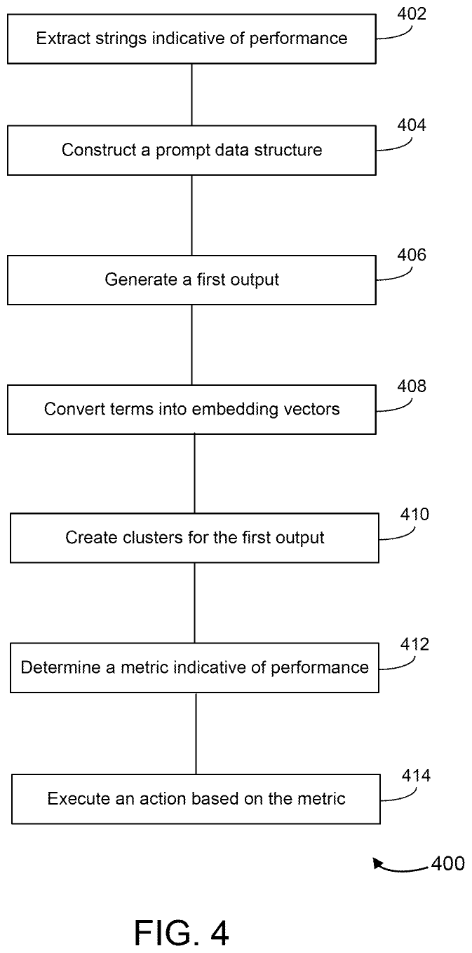

FIG. 4 depicts an example flow chart of a method 400 for performance determination of digital components based on machine learning. The method 400 can be performed by one or more systems or components depicted in FIG. 1 or FIG. 5, including, for example, a computing system 102, client devices 134, or a computer system 500. While the steps of the method 400 are described according to an order, any subset or all of the steps can be performed in any order, simultaneously, or omitted. At ACT 402, the computing system can extract strings indicative of performance of one or more digital components configured to render via client devices. The computing system can extract the strings from electronic evaluation surveys executed via the client devices over a network.

At ACT 404, the computing system can construct a prompt data structure. The computing system can construct the prompt data structure for input into a first model including a transformer neural network. The prompt data structure can be formulated based on i) the strings, ii) an indication of the one or more digital components, iii) an instruction to identify an aspect of the strings, and iv) a constraint on a size of output by the first model.

At ACT 406, the computing system can generate a first output including aspects and terms extracted from the strings that are associated with the aspects generated by the first model. The computing system can generate the first output via input of the prompt data structure into the first model.

At ACT 408, the computing system can convert the terms of the first output into embedding vectors. At ACT 410, the computing system can create clusters for the first output of the first model. The computing system can create the clusters via input of the embedding vectors into a second model trained with machine learning to cluster.

At ACT 412, the computing system can determine a metric indicative of performance of the one or more digital components. The computing system can determine the performance based on a count of the strings associated with a cluster of the clusters. At ACT 414, the computing system can execute an action based on the metric to control delivery of the one or more digital components.

FIG. 5 depicts an example block diagram of an example computer system 500. The computer system or computing device 500 can include or be used to implement a computing system or its components. The computing system 500 includes at least one bus 505 or other communication component for communicating information and at least one processor 510 or processing circuit coupled with the bus 505 for processing information. The computing system 500 can also include one or more processors 510 or processing circuits coupled with the bus for processing information. The computing system 500 also includes at least one main memory 515, such as a random-access memory (RAM) or other dynamic storage device, coupled with the bus 505 for storing information, and instructions to be executed by the processor 510. The main memory 515 can be used for storing information during execution of instructions by the processor 510. The computing system 500 can further include at least one read only memory (ROM) 520 or other static storage device coupled with the bus 505 for storing static information and instructions for the processor 510. A storage device 525, such as a solid-state device, magnetic disk or optical disk, can be coupled with the bus 505 to persistently store information and instructions.

The computing system 500 can be coupled via the bus 505 to a display 535, such as a liquid crystal display, or active-matrix display, for displaying information to a user such as an end user. An input device 530, such as a keyboard or voice interface can be coupled with the bus 505 for communicating information and commands to the processor 510. The input device 530 can include a touch screen display 535. The input device 530 can also include a cursor control, such as a mouse, a trackball, or cursor direction keys, for communicating direction information and command selections to the processor 510 and for controlling cursor movement on the display 535.

The processes, systems and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement can also be employed to execute the instructions contained in main memory 515. Hard-wired circuitry can be used in place of or in combination with software instructions together with the systems and methods described herein. Systems and methods described herein are not limited to any specific combination of hardware circuitry and software.

Although an example computing system has been described in FIG. 5, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, Python (e.g., an interpreted, object-oriented, high-level programming language with dynamic semantics), or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system to control performance of digital components executed on one or more client devices, comprising:
a computing system comprising one or more processors, coupled with memory, to:
extract, from a plurality of electronic evaluation surveys executed via a plurality of client devices over a network, a plurality of strings indicative of performance of one or more digital components configured to render via the plurality of client devices;
construct, for input into a first model comprising a transformer neural network, a prompt data structure formulated based on: i) the plurality of strings, ii) an indication of the one or more digital components, iii) an instruction to identify an aspect of the plurality of strings, and iv) a constraint on a size of output by the first model;
generate, via input of the prompt data structure into the first model, a first output comprising a plurality of aspects and a plurality of terms extracted from the plurality of strings that are associated with the plurality of aspects generated by the first model;
convert the plurality of terms of the first output into embedding vectors;
create, via input of the embedding vectors into a second model trained with machine learning to cluster, a plurality of clusters for the first output of the first model;
determine a metric indicative of performance of the one or more digital components based on a count of the plurality of strings associated with a cluster of the plurality of clusters; and
execute an action based at least in part on the metric to control delivery of the one or more digital components.

2. The system of claim 1, comprising:
the computing system to construct the prompt data structure with a second instruction to identify one or more sentiments associated with the plurality of strings.

3. The system of claim 1, comprising:
the computing system to construct the prompt data structure with a second instruction to identify a sentiment associated with each of the plurality of strings, wherein the sentiment indicatives one of positive, neutral, or negative.

4. The system of claim 1, comprising:
the computing system to construct the prompt data structure with the constraint on the size of the first output comprising a number of words.

5. The system of claim 1, comprising:
the computing system to identify, via the first model, a name for a first cluster of the plurality of clusters created by the second model.

6. The system of claim 1, comprising the computing system to:
construct a second prompt structure comprising: i) instructions to generate a plurality of topics for the plurality of clusters created by the second model, and ii) instructions to generate a summary based on the plurality of topics and the plurality of terms extracted from the plurality of strings; and
generate, via input of the second prompt structure into the first model, a second output comprising the plurality of topics and the summary.

7. The system of claim 1, comprising the computing system to:
generate a bar chart based on the count of the plurality of strings associated with the cluster of the plurality of clusters; and
provide the bar chart for display via a graphical user interface.

8. The system of claim 1, comprising the computing system to:
provide, for display via a graphical user interface, a bar chart that indicates the count of the plurality of strings associated with the cluster of the plurality of clusters; and
overlay, on a bar of the bar chart, the metric for a corresponding string of the plurality of strings associated with the bar.

9. The system of claim 1, comprising:
the computing system to reduce a frequency of delivery of the one or more digital components based on the metric less than or equal to a performance threshold.

10. The system of claim 1, comprising:
the computing system to increase a frequency of delivery of the one or more digital components based on the metric greater than or equal to a performance threshold.

11. A method to control performance of digital components executed on one or more client devices, comprising:
extracting, by a computing system comprising one or more processors coupled with memory, from a plurality of electronic evaluation surveys executed via a plurality of client devices over a network, a plurality of strings indicative of performance of one or more digital components configured to render via the plurality of client devices;
constructing, by the computing system, for input into a first model comprising a transformer neural network, a prompt data structure formulated based on: i) the plurality of strings, ii) an indication of the one or more digital components, iii) an instruction to identify an aspect of the plurality of strings, and iv) a constraint on a size of output by the first model;
generating, by the computing system via input of the prompt data structure into the first model, a first output comprising a plurality of aspects and a plurality of terms extracted from the plurality of strings that are associated with the plurality of aspects generated by the first model;
converting, by the computing system, the plurality of terms of the first output into embedding vectors;
creating, by the computing system via input of the embedding vectors into a second model trained with machine learning to cluster, a plurality of clusters for the first output of the first model;
determining, by the computing system, a metric indicative of performance of the one or more digital components based on a count of the plurality of strings associated with a cluster of the plurality of clusters; and
executing, by the computing system, an action based at least in part on the metric to control delivery of the one or more digital components.

12. The method of claim 11, comprising:
constructing, by the computing system, the prompt data structure with a second instruction to identify one or more sentiments associated with the plurality of strings.

13. The method of claim 11, comprising:
constructing, by the computing system, the prompt data structure with a second instruction to identify a sentiment associated with each of the plurality of strings, wherein the sentiment indicatives one of positive, neutral, or negative.

14. The method of claim 11, comprising:
constructing, by the computing system, the prompt data structure with the constraint on the size of the first output comprising a number of words.

15. The method of claim 11, comprising:
identifying, by the computing system via the first model, a name for a first cluster of the plurality of clusters created by the second model.

16. The method of claim 11, comprising:
constructing, by the computing system, a second prompt structure comprising: i) instructions to generate a plurality of topics for the plurality of clusters created by the second model, and ii) instructions to generate a summary based on the plurality of topics and the plurality of terms extracted from the plurality of strings; and
generating, by the computing system via input of the second prompt structure into the first model, a second output comprising the plurality of topics and the summary.

17. The method of claim 11, comprising:
generating, by the computing system, a bar chart based on the count of the plurality of strings associated with the cluster of the plurality of clusters; and
providing, by the computing system, the bar chart for display via a graphical user interface.

18. The method of claim 11, comprising:
reducing, by the computing system, a frequency of delivery of the one or more digital components based on the metric less than or equal to a performance threshold.

19. A non-transitory computer-readable medium storing processor executable instructions to control performance of digital components executed on one or more client devices that, when executed by one or more processors, cause the one or more processors to:
extract, from a plurality of electronic evaluation surveys executed via a plurality of client devices over a network, a plurality of strings indicative of performance of one or more digital components configured to render via the plurality of client devices;
construct, for input into a first model comprising a transformer neural network, a prompt data structure formulated based on: i) the plurality of strings, ii) an indication of the one or more digital components, iii) an instruction to identify an aspect of the plurality of strings, and iv) a constraint on a size of output by the first model;
generate, via input of the prompt data structure into the first model, a first output comprising a plurality of aspects and a plurality of terms extracted from the plurality of strings that are associated with the plurality of aspects generated by the first model;
convert the plurality of terms of the first output into embedding vectors;
create, via input of the embedding vectors into a second model trained with machine learning to cluster, a plurality of clusters for the first output of the first model;
determine a metric indicative of performance of the one or more digital components based on a count of the plurality of strings associated with a cluster of the plurality of clusters; and
execute an action based at least in part on the metric to control delivery of the one or more digital components.

20. The non-transitory computer-readable medium of claim 19, wherein the instructions further include instructions to:
construct the prompt data structure with a second instruction to identify one or more sentiments associated with the plurality of strings.
